(19) United States
(12) Patent Application Publication
(10) Pub. No.: US 2025/0290899 A1
(43) Pub. Date: Sep. 18, 2025

(54) STRUCTURAL DAMAGE DETERMINATION SYSTEM AND METHOD THEREOF

(71) Applicant: SYNTEC RESOURCES CO., LTD., Taoyuan City (TW)

(72) Inventors: KANG-FENG FAN, Hsinchu County (TW); PING-CHUN CHANG, Hsinchu County (TW)

(73) Assignee: SYNTEC RESOURCES CO., LTD., Taoyuan City (TW)

(21) Appl. No.: 19/075,824

(22) Filed: Mar. 11, 2025

Related U.S. Application Data
(60) Provisional application No. 63/565,539, filed on Mar. 15, 2024.

(51) Int. Cl. G01N 29/04

(52) U.S. Cl. CPC G01N 29/045; G01N 2291/023; G01N 2291/0289

(57) ABSTRACT

A structural damage determination system, for determining a structural damage of a mechanism under test. The structural damage determination system includes: a plurality of vibration sensors, distributed on the mechanism under test to sense the vibrations thereof, and a processor, having signal connections to the plural vibration sensors, wherein the processor includes a deep learning model with a model training mode and a model testing mode, wherein the deep learning model analyzes a plurality of sensed vibration signals from the vibration sensors, to evaluate a damage location or a damage status of the mechanism under test during motion.

### CROSS-REFERENCE TO RELATED APPLICATIONS

This application claims benefits of U.S. Provisional Patent Application Ser. No. 63/565,539 filed Mar. 15, 2024. The contents of which are hereby incorporated by reference in its entirety for all purposes.

### TECHNICAL FIELD

The present disclosure provides a structural damage determination technique, particularly a technique for evaluating the damage location and damage status in a mechanism under test through deep learning.

### BACKGROUND

In the field of structural damage detection, traditional techniques often focus on using a single sensor for detection and rely on predefined mathematical models, such as finite element analysis or empirical formulas, for calculations. This method is highly limited in accurately locating damage in complex structures. Furthermore, traditional approaches often suffer from reduced accuracy when dealing with nonlinear vibration characteristics or diverse damage patterns within structures, as the model assumptions may not align with actual conditions, allowing only rough trend predictions.

In recent years, structural response data generated by a plurality of sensors has been used to roughly predict damage locations through traditional computational methods, focusing on the rough detection of stationary or fixed-position workpieces. However, it is unable to provide precise detection for workpieces in motion or those that can deform during movement. Accurate prediction of damage locations in various practical operational conditions remains challenging.

### SUMMARY

Based on the technical requirements for structural damage detection, the present disclosure provides a structural damage determination system for evaluating the structural damage location of a mechanism under test. This structural damage determination system includes: a plurality of vibration sensors distributed on the mechanism under test for sensing vibrations of the mechanism under test; and a processor signal-connected to the vibration sensors, the processor comprising a deep learning module, the deep learning module having a model training mode, the deep learning module analyzing a plurality of sensed vibration signals from the vibration sensors to evaluate a damage location or a damage status of the mechanism under test.

According to an embodiment, the system further includes a striking device, which simulates a vibration response of the damage location or the damage status by striking the mechanism under test. The deep learning module analyzes the sensed vibration signals from the vibration sensors in the model training mode to generate a predicted damage location, wherein when the predicted damage location is within an allowable error range from a striking location, a training of the deep learning module is completed, thereby generating a damage prediction model.

According to an embodiment, the striking device is a mechanical striking device, which provides at least one strike to respectively simulate at least one vibration response at the damage location, wherein the mechanical striking device selectively has a variable force to strike the mechanism under test, to simulate a mechanical behavior or a damage mechanical behavior at the damage location.

According to an embodiment, the mechanism under test has at least one movable joint, wherein the movable joint comprises a hinge joint, a sliding joint, a ball joint, a cylindrical joint, a planar joint, a helical joint, a universal joint, a linear motion joint, a magnetic joint, a flexible joint, or a composite joint combining at least two of the aforementioned joints.

According to an embodiment, the vibration sensors are distributed in a grid matrix pattern, and are dispersed on a surface or a key structural area of the mechanism under test. According to an embodiment, a network topology of a signal connection between the vibration sensors comprises: star topology, tree topology, bus topology, ring topology, or a hybrid topology of at least two of the aforementioned topologies.

According to an embodiment, the sensed vibration signals of the vibration sensors include: amplitude, frequency, acceleration, vibration direction, and continuous time series data.

According to an embodiment, the deep learning module further includes a time series analysis model configured for analyzing temporal characteristics of vibration data.

According to an embodiment, the deep learning module is a convolutional neural network (CNN).

According to an embodiment, the deep learning module includes a geometric feature extraction unit, which extracts data features from the sensed vibration signals of the vibration sensors and groups the data features for geometric analysis. Te geometric feature extraction unit generates a virtual 3D reference line or a virtual 3D reference plane corresponding to each group of data features at a reference location in the mechanism under test, and determines the damage location based on the geometric intersections between the virtual 3D reference lines or planes from different groups.

According to an embodiment, the mechanism under test has a motion state, and the processor collects the sensed vibration signals from the vibration sensors to form a continuous time series data. The deep learning module analyzes the continuous time series data, evaluates the vibration response of the mechanism under test to the motion state, to generate a background motion vibration mode. The geometric feature extraction unit modifies an algorithm compensation method of the geometric feature extraction unit based on this background motion vibration mode to reduce an impact of the background motion vibration mode, and generates a compensated virtual 3D reference line or a compensated virtual 3D reference plane according to the adjusted algorithm compensation method. Subsequently, the geometric feature extraction unit calculates corrected geometric intersections based on the compensated virtual 3D reference line or the compensated virtual 3D reference plane to improve the accuracy of evaluating the damage location.

According to an embodiment, the geometric feature extraction unit modifies the algorithm compensation method of the geometric feature extraction unit through a noise suppression technique to reduce noise interference from a non-structural vibration. The geometric feature extraction unit calculates and updates the virtual 3D reference line or the virtual 3D reference plane based on the modified algorithm compensation method.

According to an embodiment, the processor analyzes the sensed vibration signals generated by each of the vibration sensors, determines a motion axis corresponding to each of the vibration sensors, and groups part of the vibration sensors with a same motion direction on the motion axis. The processor calculates a motion vector on the same motion axis, and performs calculations on the sensed vibration signals within a same group; and a rigid motion component on the motion axis is removed by vector cancellation, thereby obtaining an orthogonal motion vector. The deep learning module performs the model training mode based on the orthogonal motion vector to learn vibration characteristics of the mechanism under test, and then evaluates the damage location or predicts the damage status of the mechanism under test.

In another aspect, the present disclosure provides a structural damage determination method, including the following steps of: distributing a plurality of vibration sensors on a mechanism under test to generate a plurality of sensed vibration signals on the mechanism under test; connecting the vibration sensors to a deep learning module; striking at a striking location on the mechanism under test to simulate a vibration response of a damage location on the mechanism under test; collecting the sensed vibration signals by the deep learning module and processing the sensed vibration signals to generate a predicted damage location; and adjusting parameters of the deep learning module by comparing the predicted damage location with the striking location until a difference between the predicted damage location and the striking location is within an allowable error range, thereby completing training of the deep learning module.

According to an embodiment, the method further including: striking at different striking locations to generate sensed vibration signals corresponding to various vibration modes, transmitting the sensed vibration signals to the deep learning module for training, and establishing a mapping relationship between the sensed vibration signals and the different striking locations in the deep learning module.

According to an embodiment, the method further includes: striking with different forces at a same striking location to generate the sensed vibration signals corresponding to various degrees of damage, and establishing a mapping relationship between the sensed vibration signals and the degrees of damage in the deep learning module by the training of the deep learning module.

According to an embodiment, the deep learning module includes a geometric feature extraction unit, and the method further includes: extracting data features from the sensed vibration signals by the geometric feature extraction unit and performing analysis by groups based on the data features; generating, by the geometric feature extraction unit, a virtual 3D reference line or a virtual 3D reference plane corresponding to each of the groups at a reference position in the mechanism under test according to the data features of each group; and determining, by the geometric feature extraction unit, the predicted damage location based on geometric intersections between the virtual 3D reference lines or the virtual 3D reference planes from different groups.

According to an embodiment, the mechanism under test has a motion state, and the sensed vibration signals from the vibration sensors are collected to form a continuous time series data; the deep learning module analyzes the continuous time series data in real-time, evaluating a vibration response of the mechanism under test corresponding to the motion state to generate a background motion vibration mode; the geometric feature extraction unit modifies an algorithm compensation method of the geometric feature extraction unit based on the background motion vibration mode to reduce an impact of the background motion vibration mode, and generates a compensated virtual 3D reference line or a compensated virtual 3D reference plane according to the algorithm compensation method; and the geometric feature extraction unit calculates a corrected geometric intersection based on the compensated virtual 3D reference line or the compensated virtual 3D reference plane to improve the accuracy of evaluating the damage location.

The aforementioned various data can be represented in various forms such as scalars, vectors, tensors, matrices, sets, etc.

### BRIEF DESCRIPTION OF DRAWINGS

FIG. 1 illustrates a schematic diagram of a structural damage determination system according to an embodiment of the present disclosure;

FIGS. 2A, 2B, and 2C illustrate schematic diagrams of vibration sensors dispersed on the mechanism under test according to a plurality of embodiments of the present disclosure;

FIGS. 3 and 4 illustrate schematic diagrams of movable joints according to two embodiments of the present disclosure;

FIGS. 5A and 5B illustrate schematic diagrams of the network topology of signal connection between the vibration sensor and the processor according to two embodiments of the present disclosure;

FIGS. 6A and 6B illustrate the geometric feature extraction unit and the generated virtual 3D reference lines and virtual 3D reference planes according to an embodiment of the present disclosure; and

FIG. 7 illustrates a flowchart of the structural damage determination method according to an embodiment of the present disclosure.

### DESCRIPTION OF EMBODIMENTS

The foregoing and other technical contents, features, and effects of the present disclosure will be clearly presented in the following detailed description of preferred embodiments with reference to the accompanying drawings.

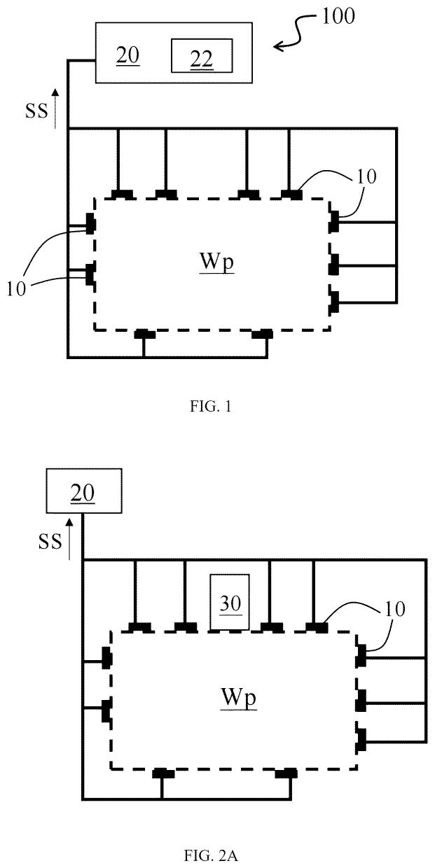

Referring to FIG. 1, in response to the aforementioned technical needs, the present disclosure provides a structural damage determination system 100, designed to evaluate the structural damage location of a mechanism under test (Wp). This structural damage determination system 100 includes: a plurality of vibration sensors 10, dispersed on the mechanism under test (Wp), to sense the vibrations of the mechanism under test (Wp); and a processor 20, signal-connected to the plurality of vibration sensors 10, the processor 20 including a deep learning module 22, which has a model training mode and a model testing mode. The deep learning module 22 analyzes a plurality of sensed vibration signals (SS) from the vibration sensors 10 to evaluate the damage location or damage status of the mechanism under test (Wp). The number of vibration sensors 10 configured on the mechanism under test (Wp) can range from a few (receiving one or two key damage locations) to hundreds. When the structure is large enough, the number of vibration sensors 10 may reach thousands, and the sensing frequency range of the vibration sensors 10 can be between 1Hz and 20kHz. The aforementioned damage location or damage status includes, for example, structural defects, breaks, fractures, mechanical damages, malfunctions, corrosion, wear, etc., in the mechanism under test (Wp). The aforementioned damage location can be, for example: the three-dimensional coordinates of the damage location in the mechanism under test (Wp) at a certain moment, or a reference position on a certain component of the mechanism under test (Wp). Components include, for example: power transmission components, movable joints, movable components, sealing components or semi-sealing components (lubrication systems, pneumatic, hydraulic), cooling systems, shock absorption components, or specific locations of structural strength or main force-bearing components. The relevant positions of these components can also be equipped with vibration sensors 10, becoming key collection points for sensed vibration signals (SS). Additionally, the signal connection method between the processor 20 and the vibration sensors 10 shown in FIG. 1 is merely illustrative. FIG. 1 shows a wired signal connection, but a wireless signal connection can also be used if needed. For the signal connection part, please refer to the description of subsequent related embodiments, which will not be detailed here.

In the aforementioned model training mode, it may include weight adjustment of the deep learning module 22, controlling the degree of gradient descent, regression calculation, switching neurons, setting labels, batch training, or controlling weights and biases through error functions or loss functions. In the model testing mode, it may include updating partial weights, supervising the learning state, and requiring a large nubmer of computational resources. Users can adjust the selections as needed.

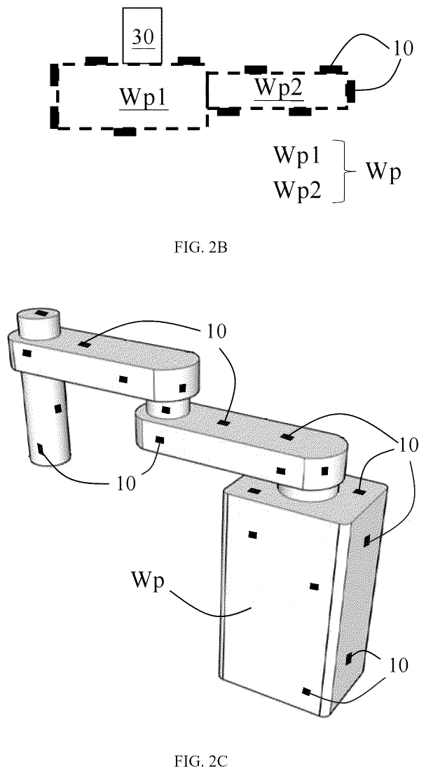

Referring to FIGS. 2A and 2B, in one embodiment, the system further includes a striking device 30, which is used to strike the mechanism under test Wp (refer to FIG. 2A), or to strike components Wp1 or Wp2 within the mechanism under test Wp (refer to FIG. 2B, where the connection between components Wp1 and Wp2 may be fixed, snap-fit, point contact, line contact, surface contact, floating contact, or contact via a medium, etc.), to simulate the vibration response of a damage location or state, and the striking location is used to simulate the damage location on the physical body of the mechanism under test Wp. In the model training mode, the deep learning module 22 analyzes the sensed vibration signals SS (refer to FIG. 2A) generated by the vibration sensors 10 (FIG. 2C, where the vibration sensors 10 are distributed on the mechanism under test Wp), to generate a predicted damage location, where the training of the deep learning module 22 is completed when the difference between the predicted damage location and the actual striking location is within the allowable error range, resulting in a damage prediction model. This embodiment can be implemented in various ways, for example, after completing the deep learning for striking at the same position, the model training mode is ended, and the damage prediction model is generated. The system can also perform other types of training, such as striking in various ways to simulate damage of different degrees or at different locations. After ending the model training mode, the generated damage prediction model can be used for subsequent sensing in various ways, generating corresponding predicted damage locations or determining damage statuses.

In an embodiment, the striking device 30 may be a mechanical striking device, providing at least one strike to simulate at least one vibration response at the damage location, wherein the mechanical striking device selectively has a variable force to strike the mechanism under test (Wp), to simulate the mechanical behavior (or damage mechanical behavior) of the damage location. The mechanical behavior or damage mechanical behavior may include: stress distribution, strain response (deformation, exhibiting elastic or plastic response of the structure), energy transfer, vibration spectrum (different striking forces can excite different modes of vibration within the structure, playing a key role in detecting the location and extent of damage), crack initiation and propagation (gradually increasing striking force can simulate the process of damage from initial crack to crack propagation, aiding in the analysis of structural damage development, as material damage typically undergoes several increasingly severe crack developments, which are often intermittently generated and discontinuous in real time).

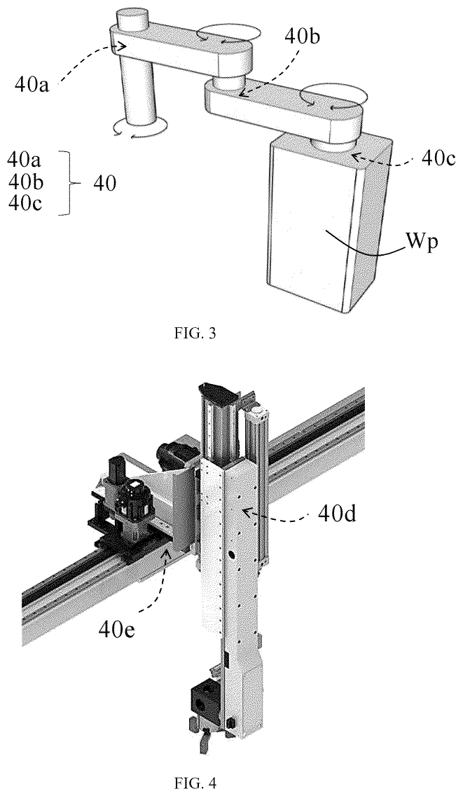

Referring to FIGS. 3 and 4, in one embodiment, the mechanism under test Wp has at least one movable joint 40, and the movable joint 40 can have various design options, such as: rotary joints 40a, 40b, 40c (FIG. 3), linear sliding joints 40d, 40e (FIG. 4). In addition, the movable joint can have other design options, such as: hinge joints, telescopic structure joints, spherical joints, cylindrical joints, planar joints, helical joints, universal joints, linear motion joints (not necessarily linear straight, possibly linear motion joints along a slide rail of any shape), magnetic joints, flexible joints (or elastic joints, which generate relative motion between the elements on both sides of the joint through the bendable/compressible/extendable properties of the material itself), or composite joints combining at least two of the aforementioned joints.

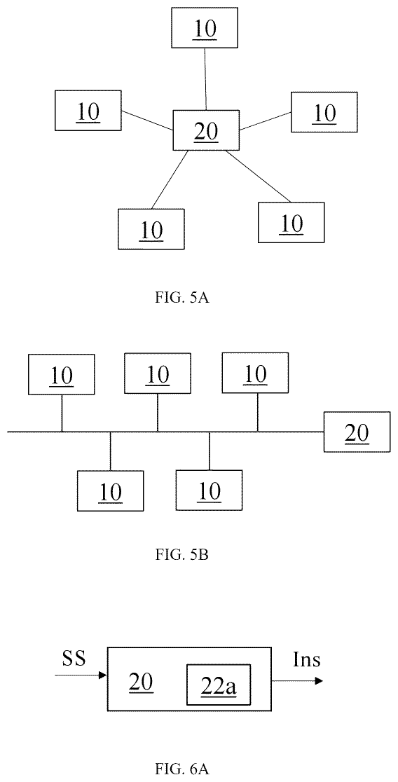

In an embodiment, the vibration sensors 10 can be distributed on the surface of the mechanism under test (Wp) (for example, in the embodiment of FIG. 2C) or in critical structural areas (to ensure comprehensive coverage of the key monitoring range of vibration signals, load balancing among nodes in the network, and reduction of transmission collisions and delays) via a grid matrix (Grid matrix, where the distribution of grid points can be uniform or non-uniform). Referring to FIG. 5A and 5 B, in an embodiment, the network topology of signal connections between vibration sensors 10, or between vibration sensors 10 and the processor 20, may include: star topology (FIG. 5A), or bus topology (Bus Topology) (FIG. 5B). Additionally, the network topology of signal connections between vibration sensors 10, or between vibration sensors 10 and the processor 20, may also include: tree topology, ring topology, or a hybrid topology combining at least two of the aforementioned network topologies in this embodiment.

In an embodiment, the sensed vibration signals SS of the vibration sensors 10 include: amplitude, frequency, acceleration (including translational acceleration and rotational acceleration, and if translational and rotational motions are defined in three-dimensional directions, it can include three-dimensional translational acceleration and three-dimensional rotational acceleration), vibration direction, and continuous time series data (such as real-time signal transmission sequences, etc.).

In an embodiment, the deep learning module 22 further includes a time series analysis model for analyzing the temporal characteristics of vibration data. In an embodiment, the time series analysis model can be based on: the mean value of the time series signals (Mean), which measures the long-term offset of the sensed vibration signals SS and can be used to identify load changes or abnormal operating conditions; the root mean square value (RMS, Root Mean Square), which reflects vibration energy and can be used to monitor the health status of mechanical equipment; the peak value (Peak Value), which can be used to detect instantaneous impacts, such as bearing damage or mechanical damage; Kurtosis, which is used to monitor abnormal changes in the signal, and the kurtosis value will rise when the system is subjected to sudden vibrations; Wavelet Transform, which is used to analyze non-stationary vibrations, such as mechanical impacts or crack growth; or Time Lag Features, where the delay changes in the sensed vibration signals SS between a plurality of sensing points can reflect structural deformation or damage propagation paths. In another embodiment, the deep learning module 22 can apply Dynamic Time Warping (DTW) to adjust the time series variations among the sensed vibration signals SS. This adjusts the temporal correspondence between the sensed vibration signals SS to compensate for time series offsets caused by motion. For example, during the movement of movable joints, continuous time series data may experience time alignment errors due to changes in motion speed, structural shape alterations, or sensing delays. The dynamic time warping technique can correct such time series mismatches to ensure signal synchronization and analysis accuracy. The deep learning module 22 provided by the present disclosure can offer the aforementioned functions to evaluate the damage location or damage status of the mechanism under test Wp. Based on this damage status inference, the deep learning module 22 can further determine the remaining useful life or provide an early warning function to predict which part of the mechanism under test Wp may soon experience damage.

In one embodiment, the deep learning module 22 is a convolutional neural network (CNN). In another embodiment, the deep learning module 22 may include a generative adversarial network (GAN) to generate additional training data to improve the training efficiency of the model. In one embodiment, the deep learning module 22 may include an attention mechanism to enhance the attention of the deep learning module 22 on locally damaged features.

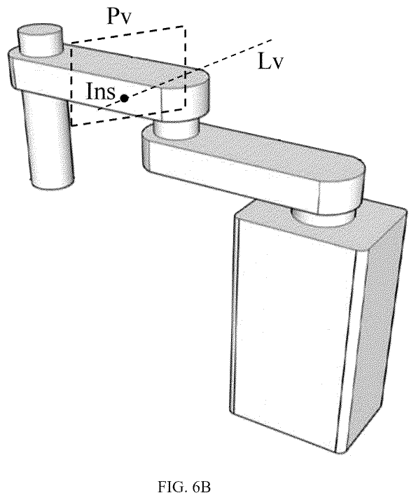

In an embodiment, the deep learning module 22 includes a geometric feature extraction unit 22a (FIG. 6A). The deep learning module 22 uses this unit to extract data features from the sensed vibration signals SS of the vibration sensor 10 (the data features may include Time Domain Features, Frequency Domain Features, Time-Frequency Domain Features, Statistical Features,

Geometric Features, etc.), and groups the data features for geometric analysis. The geometric feature extraction unit 22a, based on the data features of each group, generates a virtual 3D reference line Lv or a virtual 3D reference plane Pv corresponding to the data features of each group in the reference positioning within the mechanism under test Wp (mapped to the 3D coordinate system of the mechanism under test Wp or the reference position of a component in the mechanism under test Wp) (refer to FIG. 6B), and infers the damage location based on the geometric intersections Ins between virtual 3D reference lines Lv or virtual 3D reference planes Pv from different groups. Here, the virtual 3D reference line Lv or virtual 3D reference plane Pv represents the virtual 3D reference line Lv or virtual 3D reference plane Pv where the potential damage location may be. In FIG. 6B, the virtual 3D reference line Lv and virtual 3D reference plane Pv are only illustrative. The virtual 3D reference line Lv and virtual 3D reference plane Pv generated by applying the technology of the present disclosure can have various combinations, depending on the actual application. For example, the damage location can also be inferred according to the geometric intersections Ins of three non-parallel virtual 3D reference planes Pv.

In an embodiment, the mechanism under test (Wp) has a motion state, and the processor 20 collects the sensed vibration signals (SS) from the vibration sensors 10 to form a continuous time series data. The deep learning module 22 analyzes the continuous time series data to evaluate the vibration response of the mechanism under test (Wp) to the motion state (related to the structural deformation or dynamic load effects of the mechanism under test (Wp) in the motion state, where the same load variation under different motion states can lead to different vibration responses), thereby generating a background motion vibration mode. The geometric feature extraction unit 22a modifies the algorithm compensation method of the geometric feature extraction unit 22a based on the background motion vibration mode to reduce the influence of the background motion vibration mode, and generates a compensated virtual 3D reference line or a compensated virtual 3D reference plane according to the modified algorithm compensation method to correspond to the current structural deformation and motion load effects. Subsequently, the geometric feature extraction unit 22a calculates the corrected geometric intersections based on the compensated virtual 3D reference line or the compensated virtual 3D reference plane to improve the accuracy of predicting the damage location.

In an embodiment, if the motion state of the mechanism under test primarily originates from the ground (or the working environment), a vibration sensor can be configured in the ground or working environment in background motion vibration mode. The sensed vibration signal from this sensor serves as a background motion reference, eliminating the influence of the motion state of the mechanism under test on the sensing of other vibration sensors.

In an embodiment, by comparing the vibration modes at different speeds, the background motion vibration modes of the mechanism under test (Wp) at various specific speeds are determined. For example, the motion state of the mechanism under test (Wp) includes acceleration and deceleration processes, and the trend of the sensed vibration signals (SS) is used to determine which signals belong to the background motion vibration mode. For another example, sensed vibration signals (SS) above 5 kHz may be related to material cracks, while those below 500 Hz may be related to structural deformation and stress concentration areas. Sensed vibration signals (SS) with frequencies between 500 Hz and 5 kHz can be prioritized for evaluation to determine if they belong to the background motion vibration mode. For another example, vibration sensors located far from the damaged area but affected can be used to prioritize the evaluation of whether their sensed vibration signals are highly correlated with the background motion vibration mode. For another example, data grouping can be performed based on time windows (Sliding Window) or dynamic events (such as the moment of impact or resonance occurrence). In high-frequency vibration detection applications (such as mechanical rotating components), the model can adaptively select the appropriate data window length based on changes in rotational speed to determine which signals belong to the background motion vibration mode.

In an embodiment, the geometric feature extraction unit modifies the algorithm compensation method of the geometric feature extraction unit through a noise suppression technique to reduce the noise interference of one non-structural vibration. The geometric feature extraction unit generates a compensated virtual 3D reference line or a compensated virtual 3D reference plane based on the modified algorithm compensation method. The noise suppression techniques include but are not limited to Wavelet Denoising, Kalman Filtering, or Adaptive Filtering. The aforementioned non-structural vibration (Non-Structural Vibration) essentially includes mechanical responses that do not directly originate from within the structure but are caused by external environments, additional equipment, control systems, or interference sources. These vibrations are essentially unrelated to the inherent dynamic characteristics of the structure itself (such as natural frequency, modal vibration). They mainly come from ground vibrations, nearby machinery operation, wind load effects, environmental noise, mechanical load vibrations, electromagnetic interference, and human operation interference.

The sensing of the vibration sensor of the present disclosure can have another arrangement. In one embodiment, the processor analyzes the sensed vibration signals generated by each vibration sensor to determine the corresponding motion axes of each vibration sensor, and groups the vibration sensors with motion axes in the same direction. A plurality of groups of vibration sensors are used for real-time monitoring to obtain the acceleration and vibration state of the mechanism under test's active joints. The processor calculates the motion vectors on the same motion axis and performs calculations on the sensed vibration signals within the same group. By vector cancellation, the rigid motion components on the motion axis are removed, thereby obtaining orthogonal motion vectors. The deep learning module trains the model based on the orthogonal motion vectors to learn the vibration characteristics of the mechanism under test, and then infers the damage location or predicts the damage status of the mechanism under test. Each group of vibration sensors can be configured at different key positions of the mechanism under test, such as joints, support points, drive units, load ends, etc., and grouped accordingly. When the mechanism under test is in operation, these vibration sensors can obtain the motion acceleration of the corresponding joints. By calculating the motion vectors on the same axis, the influence of rigid motion during the motion process can be eliminated (i.e., theoretically identical motion data will cancel each other out). However, if residual signals still exist after this vector cancellation, it indicates that there may be orthogonal friction, jitter, or other abnormal phenomena on that axis. To comprehensively analyze the overall mechanical state of the mechanism under test, the system simultaneously collects data from a plurality of groups of vibration sensors and combines these data into a time-series matrix to describe the correlation between the physical state and vibration state of the mechanism under test. This matrix form not only helps mechanical engineers optimize mechanism design but also further predicts possible damage locations or damage statuses through deep learning or data modeling methods, thereby enhancing the stability and service life of the equipment. The deep learning module of the present disclosure can train the sensed vibration signals and motion data collected over a long period in this way to establish a mechanical state diagnosis model. When the system detects abnormal vibration patterns (such as high-frequency jitter or abnormal friction), it can trigger alarms or suggest maintenance in real time.

The aforementioned Axis of Motion refers to the imaginary axis along which a component or the mechanism under test primarily moves in space. It is commonly used to describe the motion behavior of rigid bodies (such as mechanical structures, robotic arms, etc.).

In addition, the assessment of a component's service life can also include the natural frequency of specific components. When the vibration amplitude increases beyond a certain threshold, it indicates that the motion or operational state has exceeded the design value, and the system can issue an alarm or suggest maintenance based on this.

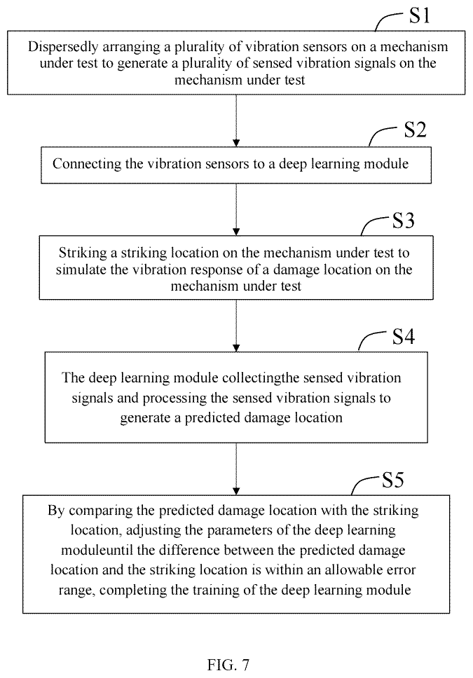

Referring to FIG. 7, according to another aspect, the present disclosure provides a structural damage determination method, which includes: dispersedly arranging a plurality of vibration sensors 10 on a mechanism under test (Wp) to generate a plurality of sensed vibration signals (SS) on the mechanism under test (Wp) (Step S1); connecting the vibration sensors 10 to a deep learning module 22 (Step S2); striking a striking location on the mechanism under test (Wp) to simulate the vibration response of a damage location on the mechanism under test (Wp) (Step S3); the deep learning module 22 collecting the sensed vibration signals (SS) and processing them to generate a predicted damage location (Step S4); and by comparing the predicted damage location with the striking location, adjusting the parameters of the deep learning module 22 until the difference between the predicted damage location and the striking location is within an allowable error range, completing the training of the deep learning module 22 (Step S5). For details of each step, please refer to the description of the aforementioned embodiments, which will not be repeated here.

Among them, the parameters of the aforementioned deep learning module 22 include at least trainable parameters and hyperparameters. Trainable parameters represent the adjustments automatically learned by the model during training, and these parameters are continuously adjusted through gradient descent to make the model's mapping ability to data more accurate. Trainable parameters include, for example: the weights and biases of neural networks, convolutional layer (CNN) parameters, recurrent neural network (RNN/LSTM/GRU) parameters, and model parameters. Hyperparameters are variables set before the start of training, which affect the stability and effectiveness of model training, and different combinations of hyperparameters can lead to significant differences in model performance. Hyperparameters include, for example: learning rate, batch size, number of epochs, optimization algorithm parameters, and regularization parameters.

In an embodiment, the structural damage determination method further includes: performing a plurality of strikes at different positions to generate a plurality of sensed vibration signals SS corresponding to various vibration modes, transmitting the sensed vibration signals SS to the deep learning module 22 for training, to establish a mapping relationship between the sensed vibration signals SS and different striking locations within the deep learning module 22 (this mapping relationship can also represent the correspondence between the sensed vibration signals SS and mechanical phenomena such as damage location and damage status). An identification and classification relationship between the sensed vibration signals SS and their corresponding positions is established, particularly for applications in Non-Destructive Testing (NDT). Striking at different positions ensures that the deep learning module 22 learns the vibration propagation characteristics of different regions. A plurality of strikes help reduce random errors (for example, this method can reduce the random errors caused by non-structural vibrations mentioned earlier), enhancing the stability of the judgments made by the deep learning module 22.

In an embodiment, the structural damage determination method further includes: performing a plurality of strikes with different forces at the same striking location to generate sensed vibration signals SS that simulate various degrees of damage. Through the training of the deep learning module 22, a mapping relationship between the sensed vibration signals SS and the degree of damage is established in the deep learning module 22. Establishing the mapping relationship between the sensed vibration signals SS and the degree of damage enhances the model's ability to recognize different degrees of damage and builds the capability to determine the relationship between vibration patterns and the degree of damage.

In an embodiment, the deep learning module 22 includes a geometric feature extraction unit 22a, and the structural damage determination method further includes: the geometric feature extraction unit 22a extracting data features from the sensed vibration signals SS and performing analysis by groups based on the data features; the geometric feature extraction unit 22a generating a virtual three-dimensional reference line Lv or a virtual three-dimensional reference plane Pv corresponding to each group at the reference positioning in the mechanism under test Wp according to the data features of each group; and the geometric feature extraction unit 22a generates the speculated damage location based on the geometric intersections Ins between the virtual three-dimensional reference lines Lv or the virtual three-dimensional reference planes Pv of each group.

In an embodiment, the mechanism under test (Wp) has a motion state, and the sensed vibration signals (SS) from the vibration sensors 10 are collected to form a continuous time series data; the deep learning module 22 analyzes the continuous time series data in real time, evaluates the vibration response of the mechanism under test (Wp) to the motion state, and generates a background motion vibration mode; the geometric feature extraction unit 22a modifies the algorithm compensation method of the geometric feature extraction unit 22a based on the background motion vibration mode to reduce the impact of the background motion vibration mode, and generates a compensated virtual 3D reference line or a compensated virtual 3D reference plane according to the modified algorithm compensation method; and the geometric feature extraction unit 22a calculates a corrected geometric intersection based on the compensated virtual 3D reference line or the compensated virtual 3D reference plane to improve the accuracy of predicting the damage location.

In an embodiment, the aforementioned processor 20 may be disposed within at least one device, and its controller may include: a Central Processing Unit (CPU), a Neural network Processing Unit (NPU), a Tensor Processing Unit (TPU), a Micro Control Unit (MCU), a Programmable Logic Controller (PLC), an Instruction Set Architecture (ISA) processor, a Microprocessor, an Application Specific Integrated Circuit (ASIC), a Digital Signal Processor (DSP), an Arithmetic Logic Unit (ALU), a Graphics Processing Unit (GPU), an Image Signal Processor (ISP), a Complex Programmable Logic Device (CPLD), a Field Programmable Gate Array (FPGA), or other similar components and combinations thereof. In one embodiment, the processor also includes a device or circuit that executes stored program code, such as a Network Interface Controller (NIC), etc.

The present disclosure has been described above with reference to preferred embodiments. However, the above description is only intended to facilitate the understanding of the content of the present disclosure by those skilled in the art, and is not intended to limit the scope of the rights of the present disclosure or the disclosed technology. Any skilled person in the art, without departing from the scope of the technical solution of this application, may utilize the disclosed technical content to make combinations, slight modifications, or alterations to create equivalent embodiments of equivalent changes.

### REFERENCE SIGNS

100: Structural Damage Determination system
10: Vibration Sensor
20: Processor
22: Deep Learning Module
22a: Geometric Feature Extraction Unit
30: Striking Device
40, 40a, 40b, 40c, 40d, 40e: Movable Joint
Ins: Geometric Intersections
Lv: Virtual 3D Reference Line
Pv: Virtual 3D Reference Plane
SS: Sensed vibration signal
S1, S2, S3, S4, S5: Steps
Wp: Mechanism under Test
Wp1, Wp2: Components.

What is claimed is:

1. A structural damage determination system for determining a structural damage of a mechanism under test, the system comprising:
a plurality of vibration sensors distributed on the mechanism under test for sensing vibrations of the mechanism under test; and
a processor signal-connected to the vibration sensors, the processor comprising a deep learning module, the deep learning module having a model training mode, the deep learning module analyzing a plurality of sensed vibration signals from the vibration sensors to evaluate a damage location or a damage status of the mechanism under test.

2. The structural damage determination system according to claim 1, wherein the system further comprises a striking device, which simulates a vibration response of the damage location or the damage status by striking the mechanism under test, and the deep learning module analyzes the sensed vibration signals from the vibration sensors in the model training mode to generate a predicted damage location, wherein when a difference between the predicted damage location and a striking location is within an allowable error range from, a training of the deep learning module is completed, thereby generating a damage prediction model.

3. The structural damage determination system according to claim 2, wherein the striking device is a mechanical striking device, which provides at least one strike to respectively simulate at least one vibration response at the damage location, wherein the mechanical striking device selectively has a variable force to strike the mechanism under test, to simulate a mechanical behavior generated at the damage location.

4. The structural damage determination system according to claim 1, wherein the mechanism under test has at least one movable joint, wherein the movable joint comprises a hinge joint, a sliding joint, a ball joint, a cylindrical joint, a planar joint, a helical joint, a universal joint, a linear motion joint, a magnetic joint, a flexible joint, or a composite joint combining at least two of the aforementioned joints.

5. The structural damage determination system according to claim 2, wherein the vibration sensors are distributed in a grid matrix pattern, and are dispersed on a surface or a key structural area of the mechanism under test.

6. The structural damage determination system according to claim 5, wherein a network topology of a signal connection between the vibration sensors comprises: star topology, tree topology, bus topology, ring topology, or a hybrid topology of at least two of the aforementioned topologies.

7. The structural damage determination system according to claim 1, wherein the sensed vibration signals of the vibration sensors comprise: amplitude, frequency, acceleration, vibration direction, and continuous time series data, wherein the acceleration comprises translational acceleration and rotational acceleration.

8. The structural damage determination system according to claim 1, wherein the deep learning module further comprises a time series analysis model configured for analyzing temporal characteristics of vibration data.

9. The structural damage determination system according to claim 1, wherein the deep learning module is a convolutional neural network (CNN).

10. The structural damage determination system according to claim 1, wherein the deep learning module comprises a geometric feature extraction unit, which extracts data features from the sensed vibration signals of the vibration sensors and groups the data features for geometric analysis, wherein the geometric feature extraction unit generates a virtual 3D reference line or a virtual 3D reference plane corresponding to each group of data features at a reference location in the mechanism under test, and determines the damage location based on the geometric intersections between the virtual 3D reference lines or planes from different groups.

11. The structural damage determination system according to claim 10, wherein the mechanism under test has a motion state, and the processor collects the sensed vibration signals from the vibration sensors to form a continuous time series data;
wherein, the deep learning module analyzes the continuous time series data, evaluates the vibration response of the mechanism under test to the motion state, to generate a background motion vibration mode; and the geometric feature extraction unit modifies an algorithm compensation method of the geometric feature extraction unit based on this background motion vibration mode to reduce an impact of the background motion vibration mode, and generates a compensated virtual 3D reference line or a compensated virtual 3D reference plane according to the adjusted algorithm compensation method; and,
the geometric feature extraction unit calculates corrected geometric intersections based on the compensated virtual 3D reference line or the compensated virtual 3D reference plane to improve the accuracy of evaluating the damage location.

12. The structural damage determination system according to claim 10, wherein the geometric feature extraction unit modifies the algorithm compensation method of the geometric feature extraction unit through a noise suppression technique to reduce noise interference from a non-structural vibration; and the geometric feature extraction unit generates the compensated virtual 3D reference line or the compensated virtual 3D reference plane based on the modified algorithm compensation method.

13. The structural damage determination system according to claim 1, wherein the processor analyzes the sensed vibration signals generated by each of the vibration sensors, determines a motion axis corresponding to each of the vibration sensors, and groups part of the vibration sensors with a same motion direction on the motion axis; and the processor calculates a motion vector on the same motion axis, and performs calculations on the sensed vibration signals within a same group; and a rigid motion component on the motion axis is removed by vector cancellation, thereby obtaining an orthogonal motion vector; and the deep learning module performs the model training mode based on the orthogonal motion vector to learn vibration characteristics of the mechanism under test, and then evaluates the damage location or predicts the damage status of the mechanism under test.

14. A structural damage determination method, comprising the following steps of:
distributing a plurality of vibration sensors on a mechanism under test to generate a plurality of sensed vibration signals on the mechanism under test;
connecting the vibration sensors to a deep learning module;
striking at a striking location on the mechanism under test to simulate a vibration response of a damage location on the mechanism under test;
collecting the sensed vibration signals by the deep learning module and processing the sensed vibration signals to generate a predicted damage location; and
adjusting parameters of the deep learning module by comparing the predicted damage location with the striking location until a difference between the predicted damage location and the striking location is within an allowable error range, thereby completing training of the deep learning module.

15. The structural damage determination method according to claim 14, wherein the method further comprises: striking at different striking locations to generate sensed vibration signals corresponding to various vibration modes, transmitting the sensed vibration signals to the deep learning module for training, and establishing a mapping relationship between the sensed vibration signals and the different striking locations in the deep learning module.

16. The structural damage determination method according to claim 14, wherein the method further comprises: striking with different forces at a same striking location to generate the sensed vibration signals corresponding to various degrees of damage, and establishing a mapping relationship between the sensed vibration signals and the degrees of damage in the deep learning module by the training of the deep learning module.

17. The structural damage determination method according to claim 14, wherein the deep learning module comprises a geometric feature extraction unit, and the method further comprises:
extracting data features from the sensed vibration signals by the geometric feature extraction unit and performing analysis by groups based on the data features;
generating a virtual 3D reference line or a virtual 3D reference plane corresponding to each of the groups at a reference position in the mechanism under test according to the data features of each group; and
determining the predicted damage location based on geometric intersections between the virtual 3D reference lines or the virtual 3D reference planes from different groups.

18. The structural damage determination method according to claim 17, further comprising:
the mechanism under test having a motion state, and collecting the sensed vibration signals from the vibration sensors to form a continuous time series data;
the deep learning module analyzing the continuous time series data in real-time, evaluating a vibration response of the mechanism under test corresponding to the motion state to generate a background motion vibration mode;
the geometric feature extraction unit determining an algorithm compensation method of the geometric feature extraction unit based on the background motion vibration mode to reduce an impact of the background motion vibration mode, and generating a compensated virtual 3D reference line or a compensated virtual 3D reference plane according to the algorithm compensation method; and
the geometric feature extraction unit calculating a corrected geometric intersection based on the compensated virtual 3D reference line or the compensated virtual 3D reference plane to improve the accuracy of evaluating the damage location.
